(19) United States
(12) Patent Application Publication
(10) Pub. No.: US 2014/0122518 A1
(43) Pub. Date: May 1, 2014

(54) CODELESS ARRAY VALIDATION

(71) Applicant: HEWLETT-PACKARD DEVELOPMENT COMPANY, L.P., Houston, TX (US)

(72) Inventors: Yochay Alufer, Petach Tikva (IL); Yossi Neeman, Petach Tikva (IL)

(73) Assignee: Hewlett-Packard Development Company, L.P., Houston, TX (US)

(21) Appl. No.: 13/662,849

(22) Filed: Oct. 29, 2012

(51) Int. Cl. G06F 17/30

(52) U.S. Cl. 707/769; 707/E17.108; 707/E17.044

(57) ABSTRACT

Systems, methods, and machine-readable and executable instructions are provided for codeless array validation. Codeless array validation can include selecting a number of operations associated with processing organizational data, where each of the number of operations includes a number of input schemas and a number of output schemas. Codeless array validation can include constructing a number of rules including the number of input schemas and the number of output schemas. Codeless array validation can include querying a web service, receiving an array response for the organizational data from the web service, and validating the array response codelessly by checking the number of rules against each of a number of data elements comprising the array response.

### BACKGROUND

Organizations may employ processing of organization data, for instance, XML Extensible Markup Language (XML) data. XML data and related arrays may be involved in business computing infrastructure and underlying protocols, such as the Simple Object Access Protocol (SOAP) and web services.

### BRIEF DESCRIPTION OF THE DRAWINGS

FIG. 1 illustrates a block diagram of an example method for codeless array validation according to the present disclosure.

FIG. 2 depicts an environment in which various examples may be implemented according to the present disclosure.

FIG. 3 illustrates a diagram of an example computing system according to the present disclosure.

### DETAILED DESCRIPTION

Validation of data can be utilized to inform a client of an existence, a characteristic (e.g., a value), and/or a location of a data element within the data (e.g., a data array). With increasing pressure on organizations to improve performance the organizations may seek to increase efficiency associated with data analysis, for instance, by pursuing efficient validation of data, for example, data retrieved from a web service.

Techniques for data analysis (e.g., array validation) can utilize code, for example, web service specific code. That is, such techniques can utilize code specific to each individual web service and/or each instance of data analysis, which may be displayed to a user developing the same. Code specific analysis of data has proven to be complex and/or costly. A cost to analyze data can, for instance, include wages of employees corresponding to time spent training on how to code and/or performing coding associated with data analysis (e.g., for individual web services), among other costs. The cost and/or time associated with such techniques may be undesirable for some applications (e.g., array validation).

In contrast, examples of the present disclosure include methods, systems, and machine-readable and executable instructions for codeless array validation (e.g., validation of data arrays). As used herein, codeless array validation refers to data validation performed without displaying any portion of the data (e.g., an array response for the organizational data) received from querying a web service and without inputting code (e.g., program code input by a user), for instance, code related to the received data and/or the array response. For example, an array response can be codelessly validated without displaying any of the data received from querying a server device (e.g., a web service) and without a prompt (e.g., without display of a prompt) for coding relating to the array response.

An example of a method for codeless array validation includes selecting a number of operations associated with processing organizational data. Each of the number of operations can include a number of input schemas and a number of output schemas. In various examples, a number of rules can be constructed to include the number of input schemas and the number of output schemas. In various examples, a web service (e.g., a web site) can be queried and an array response for the organizational data can be received from the web service. In various examples, the array response can be validated codelessly by checking the number of rules against each of a number of data elements included in the array response.

Such a codeless array validation can, for example, ensure existence of specific data element, a characteristic of a specific data element (e.g., a value), and/or a location associated with a specific data element within the array (e.g., an array response) without display of any portion of the array response. Advantageously, this can enable applying consistent and measurable means to a web service (e.g., data received from a web service) under test. Such a means can identify data validation issues within data (e.g., an invalid data array), among other data issues that can affect real users.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As will be appreciated, elements shown in the various examples herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, “a number of” an element and/or feature can refer to one or more of such elements and/or features. As used herein, “a” or “a number of” something can refer to one or more such things. For example, “a number of widgets” can refer to one or more widgets. In addition, “for example” and similar phrasing is intended to mean, “by way of example and not by way of limitation”.

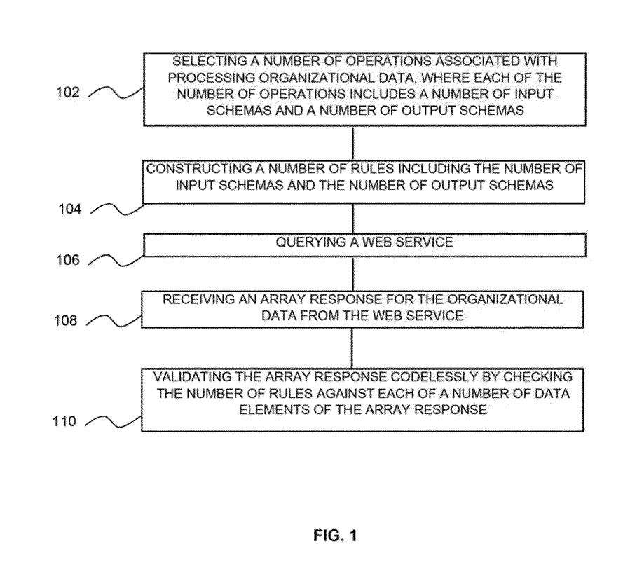

FIG. 1 illustrates a block diagram of an example method for codeless array validation according to the present disclosure. At block 102, the method can include selecting a number of operations associated with processing organizational data. Selecting can include executing instructions stored in memory to select a number of operations associated with organizational data. The number of operations can be task specific activities for analyzing and/or processing organizational data (e.g., an array response for the organizational data received from a web service). For instance, the number of operations can include task specific activities relating to existing organizational policies, organizational guidelines, or organizational operational procedures. For example, a task specific activity can include checking the accuracy of organizational data (e.g., entry level data). As used herein, organizational data includes data associated with an organization. For instance, the organizational data can be associated with organizational policies, organizational guidelines, and/or organizational procedures, among other types of organizational data.

The number of operations can, for example, be requested and received (e.g., imported) from a web service. For example, a request can identify a domain specific to a web service (e.g., a uniform resource locator (URL)), and can include additional data and/or parameters being passed to the server associated with that domain. Examples of requests can include GET and POST requests, among others suitable to request the number of operations, as described herein. However, the disclosure is not so limited. That is, a request can be made to and an array response (e.g., a data array) can be received from any suitable server device, for example, a web server, an application server, or a data server. Alternatively or in addition, the number of operations can, for example, be requested and received from a memory resource, as described herein.

Among various examples, the received data (e.g., the number of operations) can be in web service design language (WSDL) (e.g., WSDL 2.0). WSDL refers to an Extensible Markup Language (XML)-based language that is used for describing the functionality offered by a Web service. XML is a general-purpose specification for creating custom markup language. A WSDL description of the functionality offered by a Web service (e.g., a WSDL file) can provide a machine-readable description (e.g., metadata) of how the web service can be called, what parameters the web service expects to receive (e.g., the number of input schemas), and/or what data structures it can return (e.g., the number of output schemas). That is, the number of operations can enable codeless array validation (e.g., codelessly validating an existence, a characteristic, and/or a location of a number of data elements with an array).

Each of the number of operations (e.g., associated with processing organizational data) can include a number of input schemas and/or a number of output schemas. The number of input schema can include alpha, numeric, and/or alpha-numeric data based upon the number of operations (e.g., specific to an operation of the number of operations), among other types of data. The number of output schema can include alpha, numeric, and/or alpha-numeric data, among other types of data. The number of outputs can be based upon expected outputs from the number of operations (e.g., specific to an operation of the number of operations) and/or the number of inputs (e.g., specific to a particular input of the number of input schemas). In some examples, the number of operations, the number of input schemas, and/or the number of output schemas can be displayed via a graphical display, for example by a graphical user interface, as described herein.

At block 104, a number of rules including the number of input schemas and the number of output schemas can be constructed. Constructing can include executing instructions stored in memory to construct a number of rules. A “rule” includes (e.g., defines) a set of requirements to be fulfilled. A rule can be used to codelessly validate data (e.g., an array response) and, thus, one can determine whether the data matches the rule or not (e.g., the data is valid or invalid). That is, rules are statements to be fulfilled for given data (e.g., a number of data elements of an array response) to be determined to be valid. For example, in an XML array, data element A may have exactly one sub-data element B in order to match a given rule. The number of rules can relate to an existence, a characteristic (e.g., a value), and/or a location associated with any of the number of data elements (e.g., within an XML array), as described herein. For example, the number of rules can have at least one value associated with the number of data elements to match the rule, all values of the number of data elements to match the rule, and/or at least one of the number of data elements to be at a fixed (e.g., a specific) position to match the rule, among other rules indicating matching of the number of data elements.

The number of rules can be directed to any number of the number of data elements. In some examples, the number of rules can include a rule having (e.g., requiring) all the number of data elements match the rule. For example, a rule can indicate that all data elements are of a certain type (e.g., data elements relating to a characteristic of a person). In some examples, the number of rules can include a rule having at least one of the number of data elements match the rule (e.g., that at least one of the number of data elements contain a specific name of a person (e.g., John)). Alternatively or in addition, in some examples, the number of rules can include a rule having at least one of the number of data elements being at a fixed position to match the rule. A fixed position can be a location (e.g., within a data array) associated with a first data element of the number of data elements with respect to a location within the overall array and/or a location of one or more of the number of data elements. For example, data element A can be at a given location with respect to data element B (e.g., within the array response).

In some examples, the number of rules includes two or more rules. For example, a first rule can have all data elements include a numeric value and a second rule can have at least one of the data elements include a numeric value greater than 100. However, the present disclosure is not so limited. That is, any suitable number of rules can be employed to analyze (e.g., codelessly validate) any data element and/or characteristic (e.g., location of a data element) present in the number of data elements. The number of rules can include predefined policies (e.g., input schema and/or output schema corresponding to an operation of the number of operations) that provide a basic framework, although the rules can be flexible so as integrate additional rules that are later developed.

At block 106, a web service can be queried. Querying can include executing instructions stored in memory to query a web service. A web services refers to hardware, firmware, and/or software that deliver web content (e.g., from a web site). Examples of such a query include GET and POST requests, among others suitable to query the server devices (e.g., a web service). Such a query can be provided in any suitable language. For example, XQuery, C#, and/or XPath languages, among other languages suitable to query the server devices (e.g., a web service) and/or enable codeless array validation, as described herein.

In some examples, querying a web service can be performed at a predetermined time. For example, the predetermined time could correspond to a time generally associated with a comparatively low number of users for a given web service (e.g., during nighttime hours). The predetermined time can be a regularly scheduled time (e.g., reoccurring) and/or a time specified by a user (e.g., a network administrator).

At block 108, an array response for the organizational data can be received from the web service. Receiving can include executing instructions stored in memory to receive an array response for the organizational data from the web service. As used herein, an array response includes a data array response. For example, receiving the array response can include receiving an XML array from the web service.

In various examples, the received array response can be maintained (e.g., stored) without display of any portion of the array response (e.g., without display of XML data), for instance, in native format. In some examples, the received array can be checked against an XML grammar schema for validity (e.g., that all expected output schema are present) and/or format (e.g., compliance with XML protocols).

At block 110, the array response can be codelessly validated by checking the number of rules against each of a number of data elements of the array response. In some examples, the number of rules can be translated into C# language (e.g., using C# code), for example, as shown below in example 1.

### Example 1

### Example Rule Shown as C# Program Code

```
private void set_StServiceCallActivity5_checkpoints(STActivityBase
activity)
{
    // Checkpoint 1
    IVTDGetter actualValueGetter1 = new VTDXPathGetter(new
    VTDPropertyInfoBase(“OutputEnvelope”,
        |“/*[local-name(.)=‘Envelope’][1]/*[local-name(.)=
        ‘Body’][1]/*[local-name(.)=‘EchoPersonArrayResponse’][1]/
        *[local-name(.) [symbol]
    IVTDSetter actualValueSetter1 = new
    VTDCheckpointSetter(XmlTypeCode.Int);
    BindDirection actualBindDirection1 = new
    BindDirection(_flow.StServiceCallActivity5, actualValueGetter1,
    actualValueSetter1);
    CpValObj valueActualObject1 = new
    CpValObj(actualBindDirection1, XmlTypeCode.Int, false);
    CpValObj valueExpectedObject1 = new CpValObj(“77”,
    XmlTypeCode.Int);
    ValueCPRule cpRule1 = new ValueCPRule(valueActualObject1,
    valueExpectedObject1, PrimitiveTypeCP.SmallerThan, “<”, false);
    ArrayElementCPRule arrayElementCPRule1 =
    new ArrayElementCPRule( );
    ArrayBaseCPRule arrayAllCpRule1 = new
    ArrayAllCPRule(“/*[local-name(.)=‘Envelope’][1]/
    *[local-name(.)=‘Body’][1]/*[local-name [symbol]
    arrayElementCPRule1.AddRule(cpRule1);
    arrayAllCpRule1.AddRule(arrayElementCPRule1);
    activity.AddCheckpointRule(arrayAllCpRule1);
} [symbol]
indicates data missing or illegible when filed
```

Example 1 can represent an example rule of the number of rules as translated into C# program code. Such a rule can be used to codelessly validate an array response, as described herein. An example of an array response is shown below as example 2.

### Example 2

### Example XML Array Response Including Three Data elements

```
- <soap:Envelope xmlns:xsd=“http://www.w3.org/2001/
XMLSchema”xmlns:xsi=“http://www.w3.org/2001/XMLSchema-
instance” xmlns:soap=
“http://schema.xmlsoap.org/soap/envelope/”>
  - <soap:Body>
    - <EchoPersonArrayResponse xmlns=“http://tempuri.org/”>
      - <EchoPersonArrayResult>
          - <Person>
              <Name>John</Name>
              <Age>44</Age>
            </Person>
          - <Person>
              <Name>John</Name>
              <Age>32</Age>
            </Person>
          - <Person>
              <Name>John</Name>
              <Age>20</Age>
            </Person>
        </EchoPersonArrayResult>
      </EchoPersonArrayResponse>
    </soap:Body>
</soap:Envelope>
```

Codeless array validation can be performed to validate the array response. Codeless array validation can be performed by counting a number of data elements in the array response and checking a number of rules against each of the number of data elements.

in various examples, a count function can count a number of data elements in the array response to identify a total number of data elements in the array response. An example of a count function is a count Xpath function. In various examples, indexing can be performed on an array response to identify a location associated with each of the number of data elements. Examples of indexing include relational indexing, spatial indexing, among others.

In various examples, a number of operators can be used to check a number of rules against each of the number of data elements. For instance, the number of operators can include an equals (e.g., =), a not equal (e.g., !=), a greater than (e.g., >), a less than (e.g., <), a greater than or equal to (e.g., >=), and/or a less than or equal to (e.g., operator, among other suitable types of operators. In various examples, a user can select the number of operators, for instance, via the graphical user interface. For example, a user may select the number of operators from a drop down box and/or may drop and drag a desired operator of the number of operators into a designated area (e.g., a location on the graphical user interface). The number of operators can be provided (e.g., translated) in any suitable program code, for example C++ code, without display of the program code (e.g., native code) to the user.

Alternatively or in addition, in some examples, a number of functions can be used to check a number of rules against each of the number of data elements (e.g., a string including a number of data elements). For example, the number of functions can include a start function (e.g., the number of data elements starts with a given data element including a given characteristic), an ends function (e.g., the number of data elements ends with a given data element including a given characteristic), and/or a contains function (e.g., the number of data elements includes a given data element including a given characteristic), among other functions. In some examples, a user can select the number of functions, for instance, via the graphical user interface. For example, a user may select the number of functions from a drop down box and/or may drop and drag a desired function of the number of functions into a designated area (e.g., a location on the graphical user interface). The number of functions can be provided (e.g., translated) in any suitable program code, for example C++ code, without display of the program code (e.g., native code) to the user.

As shown in example 2, an array response can include a number of data elements (e.g., person) based upon the number of input and the number of output schema. For example, an input schema of the number of input schema can request that all “person” data elements include a “name”. An output schema of the number of output schema can request that all “person” data elements include an “age”. That is, the array response can include “person’ data elements including both a “name” and an “age”, as shown in example 2.

The number of rules, the number of operators, and/or the number of functions, among others, can be used to validate such a response array. For example, a rule can request that all person data elements have a name “John” (e.g., a person data element includes the name John) and have an age value of “less than 70 years old” (e.g., a person data element includes an age less than 70 years old). An example validation of such a rule can include having at least one of the number of data elements (e.g., “Person” data elements) in the array match the rule in order to be valid. As shown in example 2, three returned data elements of the response array match such a rule. That is, three data elements include persons named “John” and include an age “under 70 years old”. In some examples, an indication of validity (e.g., a “valid” denotation) of the array response can be outputted, for example, via the graphical user interface 232, as described herein.

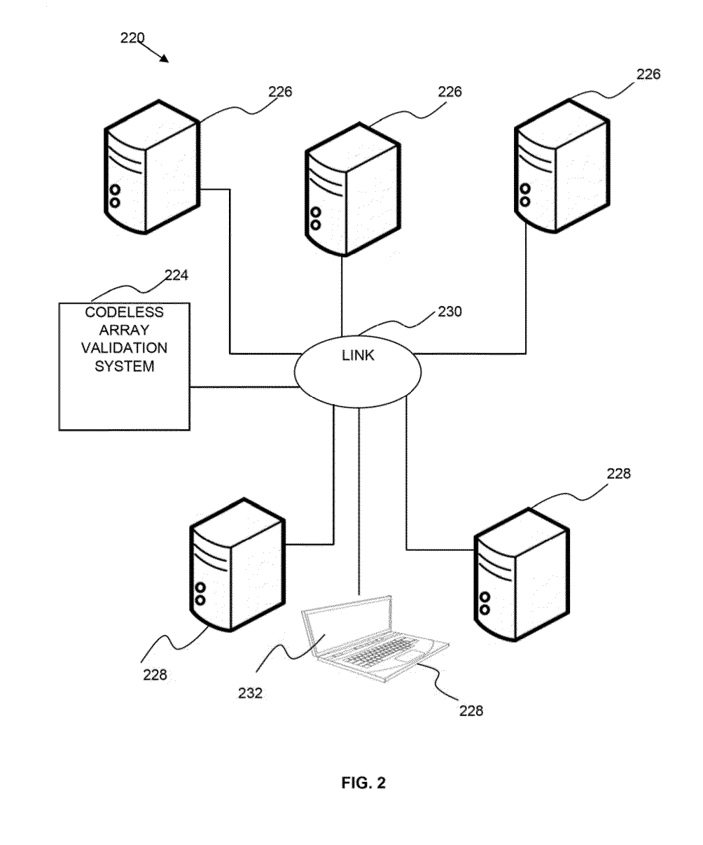

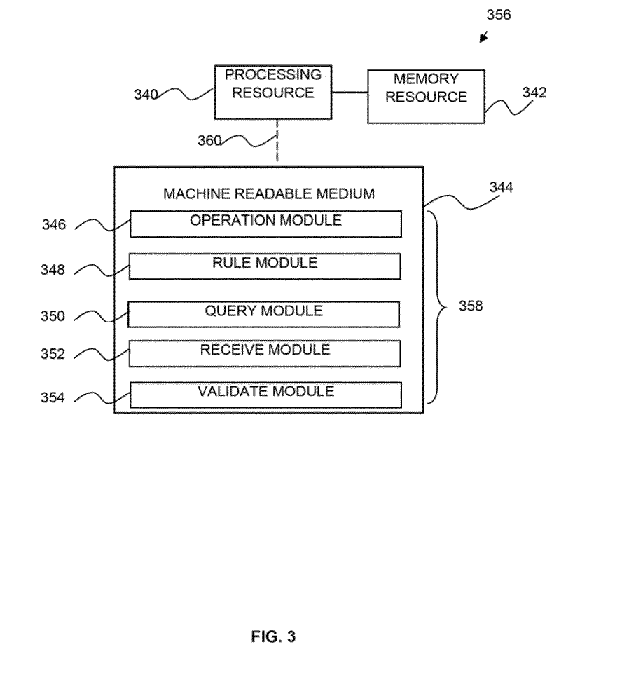

FIG. 2 depicts an environment in which various examples may be implemented according to the present disclosure. Environment 220 is shown to include codeless array validation system 224, server devices 226, client devices 228, and a link 230. The codeless array validation system 224, described with respect to FIGS. 1 and 3, represents generally a combination of hardware and programming configured to codelessly validate arrays (e.g., a data array).

Specific example of environments can include IBM WebSphere Application Server®, BEA WebLogic Application Server®, Microsoft.NET®, IBM mainframe CICS (Customer Information Control System)®, IBM mainframe Information Management System (IMS), IBM WebSphere MQ®, TIBCO EMS®, and SONIC MQ® asynchronous messaging environment running on IBM mainframe zOS platform, various Unix®, and Microsoft Windows® platforms.

In the example of FIG. 2, data arrays (e.g., an array response) represent data that can be received from a number of server devices 226. Server devices 226 represent generally any computing devices configured to respond to network requests received from client devices 228. A given server device 226 can include a web server, an application server, or a data server, among other types of servers. Client devices 228 represent generally any computing devices configured with browsers or other applications to communicate such requests and receive and process the corresponding responses. In some examples, client devices 228 can include a graphical display (e.g., a graphical user interface 232). Link 230 represents generally one or more of a cable, wireless, fiber optic, or remote connections via a telecommunication link, an infrared link, a radio frequency link, or any other connectors or systems that provide electronic communication. The link 230 can include a link to, for example, an intranet, the Internet, or a combination of both, among other communication interfaces. Link 230 can also include intermediate proxies, routers, switches, load balancers, and the like.

FIGS. 2-3 depict examples of physical and logical components for implementing various examples. FIG. 2 depicts a codeless array validation system 224 in communication with server devices 226 and client devices 228 to codelessly validate arrays, as described herein. FIG. 3 illustrates a diagram of an example computing system according to the present disclosure. The computing system 356 can utilize software, hardware, firmware, and/or logic to perform a number of functions.

The computing system 356 can be a combination of hardware and program instructions configured to perform a number of functions. The hardware, for example, can include a number of processing resources (e.g., processing resource 340), machine readable mediums (MRM), and a number of memory resources (e.g., memory resource 342). The program instructions, e.g., machine-readable instructions (MRI) 358, can include instructions stored on the MRM 344 to implement a desired function (e.g., codeless array validation).

The processing resource 340 can be in communication with the tangible non-transitory MRM 344 storing the set of MRI 358 executable by the processing resource 340, as described herein. The MRI 358 can also be stored in remote memory managed by a server and can represent an installation package that can be downloaded, installed and executed. The computing device 356 can include memory resource 342, and the processing resource 340 can be coupled to the memory resource 342.

Processing resource 340 can execute MRI 358, which can be stored on internal or external non-transitory MRM 344. The processing resource 340 can execute MRI 358 to perform various functions, including the functions described with respect to FIG. 1 and FIG. 2, among others.

A number of modules 346, 348, 350, 352, and 354 included in MRI 358, when executed by the processing resource 340, can perform a number of functions. The number of modules 346, 348, 350, 352, and 354 can be sub-modules of other modules. For example, an operations module 346 and a rules module 348 can be sub-modules and/or be contained within a single module. Furthermore, the number of modules 346, 348, 350, 352, and 354 can comprise individual modules separate and distinct from one another.

The operations module 346 can comprise MRI 358 that can be executed by the processing resource 340 to select a number of operations associated with processing organizational data. Each of the number of operations can include a number of input schemas and a number of output schemas, as described herein. In some examples, the instructions can be executable to display the number of operations via the graphical user interface. Additionally, in some examples, the instructions can be executable to provide a drop and drag functionality associated with the number of operations via the graphical user interface. Such a display and/or functionality can enable selection of the number of operations.

In some examples, the number of input schema and/or the number of output schema can be displayed via a graphical display (e.g., the graphical user interface). In some examples, the graphical user interface can include fields to enable input of alpha, numeric, or alpha numeric data corresponding to the number of input schemas. Alternatively or in addition, in some examples, the instructions can be executable to provide a drop and drag functionality associated with the number of input schemas and/or the number of output schemas via the graphical user interface. Such a display and/or functionality can enable selection and/or input of the number of input schemas and/or the number of output schemas.

In some examples, the number of output schemas can be displayed via the graphical user interface, for example, as alpha, numeric, and/or alpha-numeric outputs. In some examples, the graphical user interface can include fields to enable input of alpha, numeric, or alpha numeric data corresponding to the number of output schemas. The number of outputs can be expected outputs based upon the number of operations (e.g., specific to an operation of the number of operations) and/or the number of inputs (e.g., specific to an input of the number of inputs). Hence, a user can select the number of operations, the number of input schemas, the number of output schemas, and/or other items displayed via the graphical user interface. In some examples, the graphical user interface can include fields to enable input of alpha, numeric, or alpha numeric data corresponding to the number of output schemas. Alternatively or in addition, in some examples, the graphical user interface can include a drop and drag functionality, for example, to enable selection of the number of operations, the number of input schemas, and/or the number of output schemas, among others items displayed via the graphical user interface.

The rule module 348 can comprise MRI 358 that can be executed by the processing resource 340 to construct a number of rules. The number of rules can include the number of input schemas and the number of output schemas, as described herein. In some example, the number of rules can include two or more rules.

A query module 350 can comprise MRI 358 that can be executed by the processing resource 340 to query a web service using the number of rules to receive an array response for the organizational data, as described herein. A receive module 352 can comprise MRI 358 that can be executed by the processing resource 340 to receive an array response without a display of any portion of the array response.

A validate module 354 can comprise MRI 358 that can be executed by the processing resource 340 to codelessly validate the array response by checking the number of rules against each of the number of data elements. The validate module 354 can run the number of rules (e.g., a number of input schemas and a number of output schemas) against each data element (e.g., as identified by a count function) of the array response. For example, a count function can proceed to identify each of the data elements in the array. The validate module 354 can check each of the data elements against the number of rules (e.g., to identify the data elements and/or count those that match (e.g. satisfy) the number of input schemas in an array response received from the receive module 352) to sequentially process the number of data elements to identify a number of data elements that match the input schema. For example, as displayed in the example array shown in Example 2, there are three person elements that match the input schema (e.g., named “John”). Hence, the validate module 354 can match the rule, for example, using a count function against the first person element in the array indentified by the count function. This can enable codeless array validation, for example, as described with respect to Example 2. That is, the count function returns three data elements that match the rule. However, the present disclosure is not so limited. That is, the validate module 354 can perform any suitable data analysis function in order to target a desired characteristic (e.g., relationships between two or more data elements) associated with the array response.

In some examples, an array response (e.g., received from a web service) can be maintained in a memory resource 342 coupled with the processing resource 340 without displaying any portion of the array response. This can enable codeless validation of the array response at a time other then when the array response is initially received (e.g., during periods of low network activity).

In some examples, the validate module 354 can output an indication of the validity of the array response via the graphical interface. An indication of validity can refer to a visual, auditory, or tactile denotation that the data array is valid or invalid. Using Example 2, the data array is valid due to the presence of a number of data elements (e.g., three data elements) including a person named “John” who is “under the age of 70”. In some examples, an indication of validity can be displayed via the graphical user interface, for example, as “passed”, corresponding to a valid array, or “failed”, corresponding to an invalid array. A visual indicator can be associated with such a graphical display, for example, “passed” can be associated with a color (e.g., green) and “failed” can be associated with a different color (e.g., red). Alternatively or in addition, in some examples the visual indicator can include a selectable icon (e.g., a hyperlink). For example, a hyperlink can enable display of a hierarchal data tree structure via the graphical display, as describe herein.

In some examples, the MRI 358 can include instructions executable to display the number of operations, the number of input schemas, the number of output schemas, and/or the number of data elements in a hierarchal tree data structure. Such a hierarchal data tree structure can enable a user to drill down to individual data elements of the number of data elements. Such a structure can enable users to readily detect and identify data elements that match and/or failed to match each of the number of rules.

In some examples, the graphical user interface can include a graphical representation including displaying a visual rendering (e.g., two and/or three dimensional) on a screen at one or more locations in association with the graphical representation displaying a number of server devices 226 (e.g., web services) to enable to requesting, receiving, and or codeless array validation (e.g., codeless validation of an array responses), as described herein. Alternatively or in addition, in some examples, displaying a visual rendering can include enabling a user viewing the graphical representation on the display screen to manipulate the representation. In some examples, the graphical user interface can be, for example, a simple application programming interface (API) or Document Object Model (DOM).

In some examples, the graphical user interface can include displaying, for example, a visual rendering of the number of input schemas and/or the number of output schemas, for example, in a number of drop down menus. This can enable a user to select a number of input schemas and a number of output schemas from those displayed via the graphical user interface. Alternatively or in addition, in some examples, the graphical user interface can include a drop and drag functionality, for example, to enable selection of the number of input schemas and/or the number of output schemas, among others. However, the present disclosure is not so limited. That is, the graphical user interface can display any number of suitable functionalities to enable codeless validation, as described herein.

In some examples, displaying the graphical representation can include: providing a legend to indicate the distinctive attributes of the number of data elements (e.g., a number of particular characteristics of the number of data elements); locations associated with each of the number of data elements; a relative location of a data element with respect to one or more of the number of data elements, a relative value of a data element with respect to one or more of the number of data elements; an overall size (e.g., a number of gigabytes) of the number of data elements; an indicator of the validity of each of the number of data elements; and/or an indicator of validity of all of the data array (e.g., an array response); among others.

In some examples, the set of instructions can include instructions to dynamically update the array response. The dynamic update can include performing the functions of any one of, or a combination of, the functions of modules 346, 348, 350, 352, and/or 354, as described with respect to FIGS. 1 and 3. The array response can be dynamically updated a predetermined number of times (e.g., a number of iterations) and/or after a preset time interval (e.g., following the initial query of a web service). The predetermined number of iterations can enable comparing of data received for different iterations and/or account for periods of time that a web service is off-line (e.g., by repeating a predetermined number of times with a predetermined delay between the iterations until a request is successfully processed by a web service).

A non-transitory MRM 344, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media, such as flash memory, electrically erasable programmable read-only memory (EEPROM), phase change random access memory (PCRAM), magnetic memory such as a hard disk, tape drives, and/or a solid state drive (SSD), etc., as well as other types of machine-readable media.

The non-transitory MRM 344 can be integral or communicatively coupled to a computing device in a wired and/or wireless manner. For example, the non-transitory MRM 344 can be an internal memory, a portable memory, and a portable disk, or a memory associated with another computing resource (e.g., enabling MRIs 358 to be transferred and/or executed across a network such as the Internet).

The MRM 344 can be in communication with the processing resource 340 via a communication path 360. The communication path 360 can be local or remote to a machine (e.g., a computer, associated with the processing resource 340), for example, to perform functions described with respect to FIG. 2 (e.g., functions of link 230). Examples of a local communication path 360 can include an electronic bus internal to a machine (e.g., a computer), where the MRM 344 is one of volatile, non-volatile, fixed, and/or removable storage medium in communication with the processing resource 340 via the electronic bus.

The communication path 360 can be such that the MRM 344 is remote from a processing resource (e.g., processing resource 340), such as in a network connection between the MRM 344 and the processing resource (e.g., processing resource 340). That is, the communication path 360 can be a network connection. Examples of such a network connection can include local area network (LAN), wide area network (WAN), personal area network (PAN), and the Internet, among others. In such examples, the MRM 344 can be associated with a first computing device and the processing resource 340 can be associated with a second computing device (e.g., a Java® server). For example, a processing resource 340 can be in communication with a MRM 344, wherein the MRM 344 includes a set of instructions and wherein the processing resource 340 is designed to carry out the set of instructions.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions (e.g., software, firmware, etc.) stored in memory and executable by a processor.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for codeless array validation comprising:
selecting a number of operations associated with processing organizational data, wherein each of the number of operations includes a number of input schemas and a number of output schemas;
constructing a number of rules comprising the number of input schemas and the number of output schemas;
querying a web service;
receiving an array response for the organizational data from the web service; and
validating the array response codelessly by checking the number of rules against each of a number of data elements comprising the array response.

2. The method of claim 1, wherein validating the array response codelessly comprises validating the array response without displaying any portion of the array response and without inputting code related to the received array response.

3. The method of claim 1, wherein receiving the array response comprises receiving an XML array.

4. The method of claim 1, wherein constructing the number of rules comprises a rule having all the number of data elements to match the rule.

5. The method of claim 1, wherein constructing the number of rules comprises a rule having at least one of the number of data elements to match the rule.

6. The method of claim 1, wherein constructing the number of rules comprises a rule having at least one of the number of data elements be at a fixed position to match the rule.

7. A non-transitory machine-readable medium storing instructions for codeless array validation executable by a processing resource to cause a computer to:
select a number of operations associated with processing organizational data, wherein each of the number of operations includes a number of input schemas and a number of output schemas;
construct a number of rules, wherein the number of rules comprise the number of input schemas and the number of output schemas;
query a web service;
receive an array response for the organizational data from the web service without a display of any portion of the array response; and
codelessly validate the array response comprising a number of data elements by checking the number of rules against each of the number of data elements.

8. The medium of claim 7, wherein the number of operations comprises a web service design language.

9. The medium of claim 7, wherein the instructions are executable to display the number of operations via a graphical user interface.

10. The medium of claim 7, wherein the instructions are executable to provide a drop and drag functionality via the graphical user interface.

11. The medium of claim 9, wherein the instructions are executable to display the number of data elements in a hierarchal tree data structure.

12. A system for codeless array validation, the system comprising a processing resource in communication with a non-transitory computer readable medium, wherein the non-transitory computer readable medium contains a set of instructions and wherein the processing resource is designed to carry out the set of instructions to:
select a number of operations associated with processing organizational data, wherein each of the number of operations comprises a number of input schemas and a number of output schemas displayed via a graphical user interface;
construct a number of rules comprising the number of input schemas and the number of output schemas;
query a web service;
receive an array response for the organizational data from the web service, wherein the array response is maintained in a memory resource coupled with the processing resource without displaying any portion of the array response;
validate the array response codelessly by checking the number of rules against each of the number of data elements; and
output an indication of validity of the array response via the graphical user interface.

13. The system of claim 12, wherein the set of instructions comprises instructions to dynamically update the array response.

14. The system of claim 13, wherein the set of instructions comprises instructions to dynamically update the array response a predetermined number of times or to dynamically update the array response after a preset time interval following the query of the web service.

15. The system of claim 12, wherein the set of instructions comprises instructions to translate the number of rules into C# code.
